(19) United States
(12) Patent Application Publication
(10) Pub. No.: US 2026/0356487 A1
(43) Pub. Date: Nov. 12, 2026

(54) ASSEMBLY OF AN ELECTRIC MOTOR AND A DEVICE FOR CONTROLLING THE ELECTRIC MOTOR, AND METHOD FOR CONTROLLING SUCH AN ASSEMBLY

(71) Applicant: SAFRAN ELECTRICAL & POWER, BLAGNAC (FR)

(72) Inventors: Samir NEHME, MOISSY-CRAMAYEL (FR); Abdoulahad THIAM, MOISSY-CRAMAYEL (FR); Guillaume DURAND, MOISSY-CRAMAYEL (FR); Mathieu ZARIN, MOISSY-CRAMAYEL (FR)

(21) Appl. No.: 19/103,034

(22) PCT Filed: Jul. 27, 2023
(86) PCT No.: PCT/EP2023/070846

§ 371 Date: Feb. 11, 2025

(30) Foreign Application Priority Data
Aug. 23, 2022 (FR) FR2208474

(51) Int. Cl. B64D 27/34; B60L 50/50; B64D 33/08; H02K 1/20; H02K 11/25; H02K 11/33; H02P 1/02; H02P 29/62

(52) U.S. Cl. CPC B64D 27/34; B60L 50/50; B64D 33/08; H02K 1/20; H02K 11/25; H02K 11/33; H02P 1/02; H02P 29/62; B60L 2200/10; B60L 2240/425

(57) ABSTRACT

An assembly of an electric motor for propelling an aircraft and a control device the. The electric motor includes a stator and a rotor and at least one cooling channel configured to be supplied with a heat transfer fluid. The control device being configured to issue a control command in order to control the rotation of the rotor. The control device also being configured to issue a heating command configured to generate a heating current in the stator in order to heat the heat transfer fluid. The heating current includes a non-zero direct component and a substantially zero quadratic component so as to limit the rotation of the rotor during heating.

### TECHNICAL FIELD

The present invention relates to the field of the electric propulsion motors used in the aeronautical field. The invention relates more particularly to the cooling of an electric propulsion motor.

In order to reduce the environmental impact of an aircraft, it has been proposed to use electric motors to propel an aircraft. The climate change is a major concern for many legislative and regulatory members around the world. Various restrictions on carbon emissions have been, are being or will be adopted by various states. In particular, an ambitious standard applies both to new types of aircrafts and to those already in circulation, requiring the implementation of technological solutions so as to bring them into line with current regulations. For several years now, the civil aviation has been working to help combat climate change.

The technological research efforts have already led to very significant improvements in the environmental performance of the aircrafts. The Applicant takes into account the impacting factors in all phases of design and development to obtain aeronautical elements and products that consume less energy, are more environmentally friendly and whose integration and use in civil aviation have moderate environmental consequences with the aim of improving the energy efficiency of the aircrafts.

Consequently, the Applicant is constantly working to reduce its negative impact on the climate through the use of virtuous development and manufacturing methods and processes that minimize greenhouse gas emissions as much as possible in order to reduce the environmental footprint of its business.

This ongoing research and development work focuses in particular on new generations of aircraft motors using electric technologies.

As is well known, an electric motor comprises a rotor mounted so that it may rotate relative to a stator. The stator is supplied by a power module, in particular a DC/AC power converter. An electric motor of this type is likely to heat up during operation and it is necessary to evacuate calories from the electric motor so as to allow a reliable operation and a long service life.

In a known way, an electric motor comprises a cooling channel wherein a heat transfer fluid, in particular oil, circulates so as to extract calories from the electric motor and ensure its cooling. To allow an optimum cooling, the temperature of the heat transfer fluid must remain within a predetermined temperature range, for example above 10 °C. If the temperature of the heat transfer fluid is too low, its viscosity will not allow an optimum cooling.

In certain cold regions of the world, the outside temperature may reach −40 °C and the temperature of the heat transfer fluid is not within the predetermined temperature range. To eliminate this disadvantage, it has been proposed in the prior art to fit a heating system between a heat transfer fluid reservoir and the electric motor so as to heat the heat transfer fluid before it is supplied to the electric motor.

A heating system of this type has a number of disadvantages, as it increases the overall dimension required in the vicinity of the electric motor and reduces the weight of the aircraft. In addition, the presence of a heating system increases the length of the cooling circuit, making it necessary to use a heat transfer fluid drive pump, which has a high weight and is bulky.

The invention thus aims to eliminate at least some of these disadvantages.

The document FR3080239A1 relates to a device and a method for estimating and correcting a measurement error of a position sensor of a rotating electric machine rotor for an electric vehicle. This document teaches how to preheat a cooling circuit in an electric vehicle.
US20070246302A1 teaches a system for preheating the oil in an oil reservoir of an aircraft.
EP2531328A0 teaches a method for heating robots in cold environments.

### PRESENTATION OF THE INVENTION

The invention relates to an assembly of an electric motor for the propulsion of an aircraft, and a control device for controlling the electric motor,
the electric motor comprising a stator and a rotor mounted so as to be movable relative to the stator, the electric motor comprising at least one cooling circuit configured to be supplied with a heat transfer fluid configured to collect calories from at least the stator of the electric motor,
the control device being configured to issue a control command configured to generate a control current in the stator of the electric motor so as to control the rotation of the rotor.

The control device is remarkable in that it is configured to issue a heating command configured to generate a heating current in the stator of the electric motor so as to heat the heat transfer fluid, the heating current comprising a non-zero direct component and a substantially zero quadratic component so as to limit the rotation of the rotor during heating.

By substantially zero, we mean a value of less than 5% of the nominal quadratic component during a command to control the rotation of the rotor. Preferably, as the electric motor has a predetermined internal friction torque, the quadratic component is less than the internal friction torque so as to prevent any rotation.

Advantageously, thanks to the invention, the electric motor is supplied only with a direct current so as to produce thermal losses without producing torque as a function of the quadratic current. These heat losses are transmitted to the heat transfer fluid, which may be brought to a current temperature at which its viscosity is optimal for cooling the electric motor. Thanks to the invention, it is not necessary to provide an additional heating device which would increase the weight and the overall dimension. The electric motor is controlled in a roundabout way to perform a heater function without supplying torque.

Preferably, the stator extends at least partially into the cooling channel. This allows the heat transfer fluid to collect the calories generated by the stator directly, thereby increasing its temperature. During the nominal operation, the heat transfer fluid may also optimally cool the stator.

Preferably, the heat transfer fluid is oil or glycolate water. The invention is particularly advantageous with these fluids, whose viscosity is a function of temperature.

According to one aspect of the invention, at least one power device is configured to supply at least the stator with the control current from an electrical power source as a function of the control command, the heat transfer fluid being configured to collect calories from the power device. Advantageously, during reheating, calories are supplied, on the one hand, by the electric motor and, on the other hand, by the power device.

Preferably, the assembly comprises at least one temperature sensor configured to measure a current temperature of the heat transfer fluid, the control device being configured to issue a heating command which is a function of the current temperature. In this way, the heating command and therefore the heating current are set as a function of the current temperature, so as to obtain the desired temperature by regulation. In this way, an optimum heat transfer fluid temperature may be achieved in a given time.

The invention also relates to an aircraft comprising an assembly as presented above

The invention also relates to a method for controlling an assembly as presented above, the cooling channel of the electric motor being supplied with the heat transfer fluid, the heat transfer fluid having a current temperature, the rotor being at a standstill, the method comprising steps consisting in:
issuing a heating command to generate a heating current in the stator of the electric motor so as to heat the heat transfer fluid, the heating current comprising a non-zero direct component and a substantially zero quadratic component so as to limit the rotation of the rotor during heating.

For example, an electric motor may be used to heat the heat transfer fluid before it is put into service and the rotor rotates.

Preferably, the cooling circuit comprises a heat transfer fluid drive pump which is activated during heating so as to collect the calories from the stator with a flow rate of heat transfer fluid.

Preferably, the method comprises the steps of:
measuring the current temperature of the heat transfer fluid,
if the current temperature of the heat transfer fluid is below a predetermined threshold temperature, issuing a heating command to generate a heating current in the stator of the electric motor so as to heat the heat transfer fluid, the heating current comprising a non-zero direct component and a substantially zero quadratic component so as to limit the rotation of the rotor during heating.

Preferably, the method comprises steps consisting of:
if the current temperature of the heat transfer fluid is greater than or equal to the predetermined threshold temperature, issuing a control command configured to generate a control current in the stator of the electric motor so as to control the rotation of the rotor.

Advantageously, if the heat transfer fluid has a current temperature suitable for cooling, the electric motor may be started directly.

Preferably, the threshold temperature is between 5° and 15 °C, preferably around 10 °C.

Preferably, the heating command is determined to increase the current temperature of the heat transfer fluid by at least 1 °C/second.

### PRESENTATION OF FIGURES

The invention will be better understood on reading the following description, given by way of example, with reference to the following figures, given by way of non-limiting examples, wherein identical references are given to similar objects.

FIG. 1 is a schematic representation of an assembly of an electric motor and a control device for controlling the electric motor according to one embodiment of the invention.

FIG. 2 is a schematic representation of an electric motor receiving a control command.

FIG. 3 is a schematic representation of an electric motor receiving a heating command.

FIG. 4 is a schematic representation of an assembly of an electric motor and a control device for controlling the electric motor according to another embodiment of the invention.

FIG. 5 is a schematic representation of steps for implementing a control method according to the invention.

It should be noted that the figures set out the invention in detail in order to implement the invention, said figures of course being able to be used to better define the invention if necessary.

### DETAILED DESCRIPTION OF THE INVENTION

With reference to FIG. 1, there is shown an assembly 1 according to the invention comprising an electric motor 2 allowing to participate in the propulsion of an aircraft.

In a known manner, as illustrated in FIG. 1, the electric motor 2 comprises a stator 21 and a rotor 22 mounted so as to be movable relative to the stator 21. In this example, the stator 21 comprises a plurality of windings which allow a rotating magnetic field to be generated when the windings are supplied. The windings may be concentric or distributed. Preferably, the electric motor 2 comprises several notches wherein the windings are mounted.

The rotor 22 is configured to interact magnetically with the stator 21 so as to drive it in rotation. In this example, the rotor 22 is housed inside the stator 21 but it goes without saying that the reverse is also possible. The invention applies to any type of electric motor 2, in particular a permanent magnet synchronous machine or a machine with a wound rotor. The rotor 22 is secured to one or more propulsion members, for example a fan or a propeller as shown in FIG. 1,

In this example, still with reference to FIG. 1, the stator 21, in particular its windings, are supplied by an electrical energy source 30 via a power device 3. Preferably, the electric motor 2 is of the three-phase type. Preferably, the electric motor 2 is also configured to operate as a generator so as to produce electrical energy to recharge the electrical energy source 30. In this example, the electrical energy source 30 is a DC source, for example an electrical battery or a fuel cell.

The power device 3, also referred as power electronics, is used to control the currents circulating in the rotor 22 so as to obtain the desired speed of rotation and/or torque of the rotor 22. The power device 3 allows to provide a DC/AC conversion to supply the stator 21. The power device 3 preferably comprises an inverter comprising a plurality of controllable switches so as to control the currents circulating in the stator 21. Such a power device 2 is known to the person skilled in the art and will not be described in further detail.

Still with reference to FIG. 1, the assembly 1 comprises a control device 5 configured to issue a control command O1 to the power device 3 so as to generate a control current I1 in the stator 21 of the electric motor 2 to control the rotation of the rotor 22. In this example, the control device 5 indirectly controls the electric motor 2 via the power device 3, but it goes without saying that in the absence of a power device 3, the control device 5 could directly control the electric motor 2. The control device 5 takes the form of a computer configured to issue a control command O1 and thus determine the control current I1 in the stator 21.

In a known way, a control current I1 may be broken down into three elementary currents for a three-phase electric motor 2. According to the Park transform, the control current I1 may also be broken down into a direct component I1d and a quadratic component I1q. As is well known, the direct component I1d represents the thermal losses, while the quadratic component I1q represents the applied torque. The direct component I1d is also used in a speed acceleration mode when the voltage is insufficient.

To control the torque of the rotor 22 of the electric motor 2, the control current I1 comprises a quadratic component I1q which is non-zero (nominal quadratic component I1q). So, depending on the command from the pilot of the aircraft, the control device 5 modifies the value of the control current I1 to obtain the desired torque of the rotor 22 of the electric motor 2. The direct composite I1d is thus reduced as much as possible to promote torque.

The electric motor 2 and the power device 3 generate calories when operating. Also, as illustrated in FIG. 1, a cooling circuit CR (dashed lines) is provided to collect calories from the electric motor 2 and the power device 3 by circulating a heat transfer fluid F, for example oil or glycolate water. In this example, the cooling circuit CR comprises a reservoir 6 wherein the heat transfer fluid F is stored and a pump 7 configured to circulate the heat transfer fluid F in the cooling circuit CR. The cooling circuit CR comprises at least one heat exchanger 8 configured to exchange the calories of the heat transfer fluid F with an external fluid Fext, for example an ambient air flow. During aircraft flight, heat exchange is important for cooling the heat transfer fluid F.

Preferably, the cooling circuit CR comprises a temperature sensor 9 for measuring the temperature of the heat transfer fluid F. The temperature sensor 9 is preferably positioned close to the reservoir 6 but it goes without saying that it could be positioned at another point in the cooling circuit CR.

During operation of the electric motor 2, the heat transfer fluid F circulates in the cooling circuit CR in a closed loop to collect calories from the power device 3 and then from the electric motor 2, which is then dissipated in the heat exchanger 8.

With reference to FIG. 1, the heat transfer fluid F circulates from upstream to downstream in the cooling circuit CR. In this example, the power device 3 is positioned upstream of the electric motor 2, but it could of course be positioned downstream. Similarly, the electric motor 2 and the power device 3 could be supplied in parallel with heat transfer fluid F.

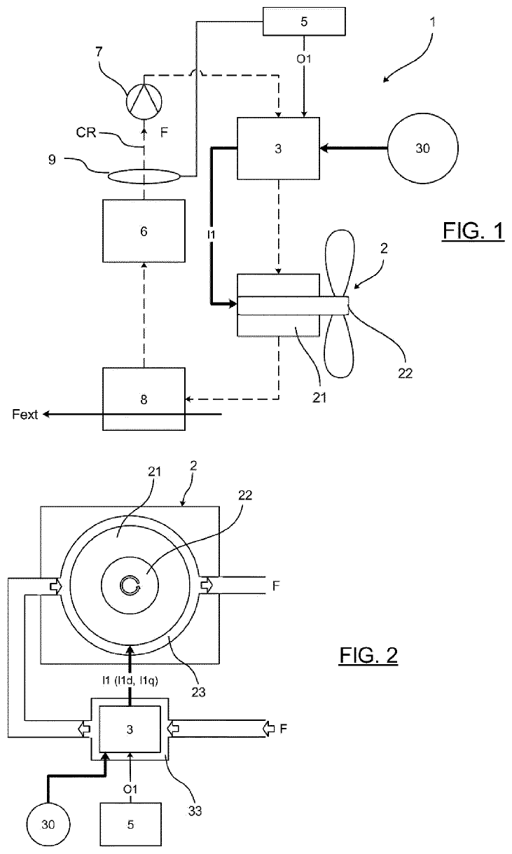

According to the invention, with reference to FIG. 2, the electric motor 2 comprises at least one cooling channel 23 configured to be supplied with the heat transfer fluid F of the cooling circuit CR. Similarly, the power device 3 comprises at least one cooling channel 33 configured to be supplied with the heat transfer fluid F from the cooling circuit CR.

In this embodiment, the stator 21 extends at least partially into the cooling channel 23 of the electric motor 2. This allows to collect the calories generated by the stator 21 during its power supply. Preferably, the stator 21 and the rotor 22 are immersed in the heat transfer fluid F to allow an optimum cooling. In particular, the windings of the stator 21 are immersed in the heat transfer fluid F. Preferably, the notches of the electric motor 2 are immersed in the heat transfer fluid F.

Similarly, the power device 3 comprises a plurality of components extending into the cooling channel 33 of the power device 3. This allows to collect the calories generated by the power device 3 when power is supplied to the stator 21, as will be shown later. Preferably, one or more components comprise fins to improve heat exchange with the heat transfer fluid F circulating in the cooling channel 33 of the power device 3, in particular a plurality of tubular fins.

According to the invention, the electric motor 2 is configured to heat the heat transfer fluid F prior to operational start-up of the electric motor 2, i.e. prior to the rotation of the rotor 22.

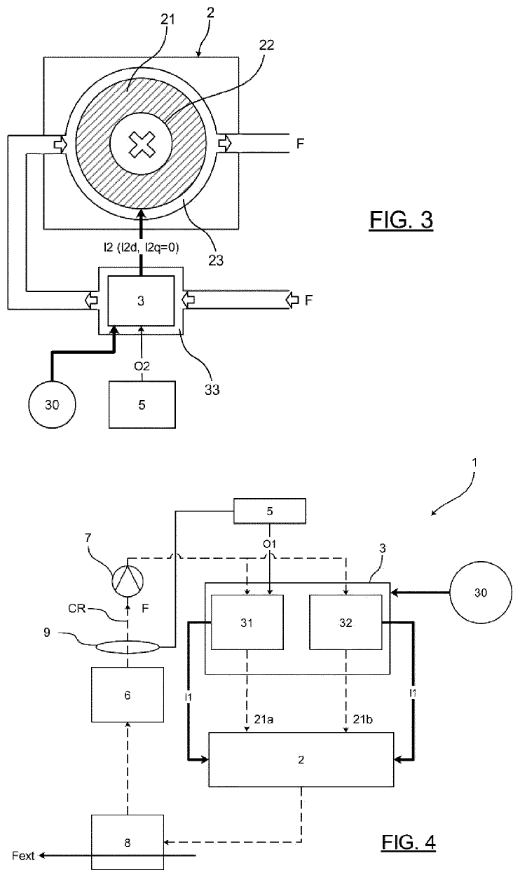

According to the invention, with reference to FIG. 3, the control device 5 is configured to issue a heating command O2 configured to generate a heating current I2 in the stator 21 of the electric motor 2 so as to heat the heat transfer fluid F located in the cooling channel 23 of the electric motor 2. The heating current I2 comprises a non-zero direct component I2d and a substantially zero quadratic component I2q so as to limit the rotation of the rotor 22 during heating.

By substantially zero, we mean that the quadratic component I2q is insufficient to rotate the rotor 22 so as to create a propulsion force. Preferably, as the electric motor 2 has a predetermined internal friction torque, the quadratic component I2q is less than the internal friction torque so as to prevent any rotation. According to a preferred aspect, the quadratic component I2q is less than 5% of the nominal quadratic component I1q determined when controlling the electric motor 2.

Thus, a heating command O2 determines a heating current I2 which generates the vast majority of heat losses by Joule effect in the stator 21 of the electric motor 2 without rotating the rotor 22 and generating a torque. This is highly advantageous as it allows the heat transfer fluid F to be heated prior to operational start-up. The direct component I2d allows to generate electrical losses and therefore Joule effect thermal energy. Thus, instead of minimizing the heat losses and maximizing the torque when the electric motor 2 is in operational service, the present invention aims to achieve a heating, preliminary to operational service, wherein the heat losses are maximized and the torque minimized.

In the example shown in FIG. 1, the power device 3 allows to supply power to a stator 21 comprising a single stator star in order to drive the rotor in rotation 22. Nevertheless, the invention also applies to a power device 3 comprising a first power supply module 31 and a second power supply module 32 which are independent and, preferably, segregated so as to increase the redundancy and the reliability as illustrated in FIG. 4. Such power supply modules 31, 32 are advantageous when the stator 21 comprises several stator stars 21a, 21b which may be power supplied independently. As shown in FIG. 4, the cooling circuit CR allows the two power supply modules 31, 32 to be cooled in parallel.

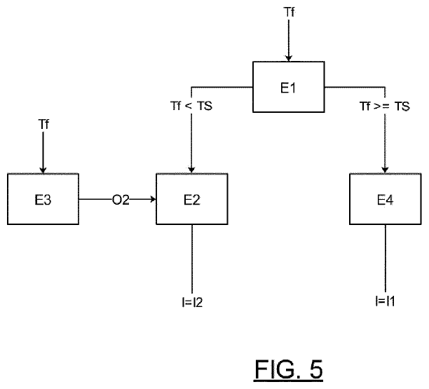

An example of the implementation of a control method according to the invention will now be presented with reference to FIG. 5.

In this example, the aircraft is stored on the ground at an airport in a cold region, for example at −40 °C, and has to carry out a flight (operational service). Due to external temperatures, the current temperature Tf of the heat transfer fluid F is below a predetermined threshold temperature Ts. Preferably, the threshold temperature Ts is between 5 °C and 15 °C, preferably around 10 °C.

Thanks to the control method according to the invention, the current temperature Tf of the heat transfer fluid F will be increased to reach the threshold temperature Ts and thus allow to collect calories optimally when the electric motor 2 is operating, i.e. with its rotor 22 rotating. As explained above, if the current temperature Tf of the heat transfer fluid F is too low, its viscosity will not allow optimum cooling.

With reference to FIG. 5, the pump 7 is activated so as to circulate the heat transfer fluid F in the cooling circuit CR. In the initial state, the electric motor 2 is not controlled and the power device 3 does not supply current to the stator 21.

The method comprises a step E1 consisting of measuring the current temperature Tf of the heat transfer fluid F, in particular by means of the temperature sensor 9.

If the current temperature Tf of the heat transfer fluid F is less than the threshold temperature Ts, the method then comprises a step E2 consisting of issuing a heating command O2 to generate a heating current I2 in the stator 21 of the electric motor 2 so as to heat the heat transfer fluid F. In practice, the temperature sensor 9 supplies the current temperature Tf of the heat transfer fluid F to the control device 5, which issues a heating command O2 as illustrated in FIG. 3. This heating command O2 modifies the position of the switches of the power device 3 so as to generate a heating current I2 comprising a non-zero direct component I2d and a substantially zero quadratic component I2q so as to limit the rotation of the rotor 22 during heating. The quadratic component I2q is so small that the rotation of the rotor 22 is zero or almost zero, which avoids generating thrust while the aircraft is in the heating phase.

The direct (non-zero) component I2d of the heating current I2 generates Joule effect heating of the stator 21, which transmits its calories to the heat transfer fluid F located in the cooling channel 23 in contact with the windings of the stator 21. In this example, the direct component I2d has a constant amplitude greater than 200 A peak, preferably of the order of 300 A peak. The preferred frequency is low, of the order of 10 Hz. This allows to generate heat losses of 16 kW. As a result, most of the current is converted into heat loss.

As the pump 7 is activated, the heat transfer fluid F gradually heats up in the cooling circuit CR in contact with the stator 21. Since the aircraft is on the ground, the heat exchanger 8 has a very low external fluid flow rate Fext. As a result, the heat exchanger 8 only slightly lowers the current temperature Tf of the heat transfer fluid F, in particular, less than the electric motor 2 increases its current temperature Tf.

Unlike conventional operation wherein the heat transfer fluid F is used to dissipate calories, the heat transfer fluid F is used to collect calories and raise its temperature.

Preferably, the method comprises a step E3 consisting of monitoring the current temperature Tf of the heat transfer fluid F and adapting the direct component I2d of the heating current I2 in order to obtain the desired temperature rise. Preferably, the heating command O2 is determined to increase the current temperature Tf of the heat transfer fluid F by at least 1 °C/second. This allows a rapid heating and avoids delaying the aircraft's flight. In this example, the current temperature Tf is increased by 30 °C in 30 seconds.

Still referring to FIG. 5, when the current temperature Tf of the heat transfer fluid F is greater than or equal to the threshold temperature Ts, for example 10 °C. The method comprises a step consisting of issuing E4 a control command O1 configured to generate a control current I1 in the stator 21 of the electric motor 2 so as to control the rotation of the rotor 22 (FIG. 2). Preferably, the control device 5 issues a control command O1 determining a control current I1 whose quadratic component Iql is non-zero so as to allow the rotation of the rotor 22.

Thanks to the invention, the current temperature Tf of the heat transfer fluid F is gradually increased so as to reach the threshold temperature Ts. At this threshold temperature Ts, the heat transfer fluid F has optimum characteristics for dissipating calories, particularly in terms of viscosity. The rotor 22 may then be set in rotation and the heat transfer fluid F allows to collect the calories induced by the rotation both in the electric motor 2 and in the power device 3. The control command O1 may then be issued so that the aircraft may carry out its flight mission.

Advantageously, if the current temperature Tf of the heat transfer fluid T is greater than or equal to the threshold temperature Ts prior to starting the electric motor 2, no heating command O2 is issued by the control device 5 and the electric motor 2 may be started directly.

Thanks to the invention, an electric motor 2 may be started safely and reliably without the addition of add-on equipment which increases the weight and the overall dimension of the aircraft. Advantageously, the control device 5 allows to supply a heating command O2 which allows the electric motor 2 to behave like an electric heater without generating torque.

1. An assembly of an electric motor for propulsion of an aircraft, and of a control device for controlling the electric motor,
the electric motor comprising a stator and a rotor mounted so as to be movable relative to the stator, the electric motor comprising at least one cooling circuit configured to be supplied with a heat transfer fluid configured to collect calories from at least the stator of the electric motor, the control device being configured to issue a control command configured to generate a control current in the stator of the electric motor so as to control the rotation of the rotor, wherein the control device is configured for:
measuring the current temperature of the heat transfer fluid,
if the current temperature of the heat transfer fluid is below a predetermined threshold temperature of between 5° and 15 °C, issuing a heating command configured to generate a heating current in the stator of the electric motor so as to heat the heat transfer fluid, the heating current comprising a non-zero direct component and a substantially zero quadratic component so as to limit the rotation of the rotor during heating
if the current temperature of the heat transfer fluid is greater than or equal to the predetermined threshold temperature, issuing a control command configured to generate a control current in the stator of the electric motor so as to control the rotation of the rotor.

2. The assembly of claim 1, wherein the stator extends at least partially into the cooling channel.

3. The assembly according to claim 1, wherein the heat transfer fluid is oil.

4. The assembly according to claim 1, further comprising a power device configured to supply at least the stator with the control current from an electrical power source as a function of the control command, the heat transfer fluid being configured to collect calories from the power device.

5. The assembly according to claim 1, further comprising at least one temperature sensor configured to measure a current temperature of the heat transfer fluid, the control device being configured to issue a heating command which is a function of the current temperature.

6. An aircraft comprising the assembly according to claim 1.

7. A method for controlling an assembly according to claim 1, the cooling channel of the electric motor being supplied with the heat transfer fluid, the heat transfer fluid having a current temperature the rotor being at a standstill, the method comprising:
measuring the current temperature of the heat transfer fluid,
the current temperature of the heat transfer fluid is below a predetermined threshold temperature of between 5° and 15 °C, issuing a heating command to generate a heating current in the stator of the electric motor so as to heat the heat transfer fluid, the heating current comprising a non-zero direct component and a substantially zero quadratic component so as to limit the rotation of the rotor during heating,
if the current temperature of the heat transfer fluid is greater than or equal to the predetermined threshold temperature, issuing a control command configured to generate a control current in the stator of the electric motor so as to control the rotation of the rotor.

8. The method according to claim 7, wherein the threshold temperature is 10 °C.

9. The method according to claim 7, wherein the heating command is determined to increase the current temperature of the heat transfer fluid by at least 1 °C/second.

10. The assembly according to claim 1, wherein the heat transfer fluid is glycolate water.
